(19) United States
(12) Patent Application Publication
(10) Pub. No.: US 2014/0339745 A1
(43) Pub. Date: Nov. 20, 2014

(54) MOLDS FOR CERAMIC CASTING

(71) Applicant: Stuart URAM, New York, NY (US)

(72) Inventor: Stuart URAM, New York, NY (US)

(21) Appl. No.: 14/280,422

(22) Filed: May 16, 2014

Related U.S. Application Data
(60) Provisional application No. 61/824,596, filed on May 17, 2013.
(60) Provisional application No. 61/925,575, filed on Jan. 9, 2014.

(51) Int. Cl. B29C 39/36; C04B 35/44

(52) U.S. Cl. CPC B29C 39/36; C04B 35/44; C04B 2235/5212; C04B 2235/3222; C04B 2235/3481; C04B 2235/3418
USPC 264/681; 264/125; 524/436; 501/153

(57) ABSTRACT

A method of making an object using mold casting, comprising the steps of applying a slip mixture into a mold fabricated by 3D printing or additive manufacturing technique, and firing the mold containing the slip mixture. A composition of a slip mixture for use with a mold fabricated by 3D printing or additive manufacturing technique, the composition comprising calcium aluminate, from 10% to 60% by weight, and a filler. Such method and composition can provide efficient and economically viable ways of fabricating objects having complex shapes and high density.

### CROSS REFERENCE TO RELATED APPLICATIONS

This application claims priority under 35 U.S.C. §119(e) to U.S. Provisional Patent Application Ser. No. 61/824,596, filed on May 17, 2013, and U.S. Provisional Patent Application Ser. No. 61/925,575, filed on Jan. 9, 2014, the contents of all of which are incorporated by reference herein in their entirety.

### FIELD OF INVENTION

The present invention generally relates to manufacture of molded objects, including but not limited to ceramic and metal objects, and molds therefor and related methods for their fabrication.

### BACKGROUND OF THE INVENTION

Three dimensional (“3D”) printing systems and related systems using additive manufacturing techniques, such as fused deposition modeling (FDM), have become more widely available in recent years and are being used to manufacture an ever increasing array of objects.

For example, 3D printing systems permit manufacture of objects having complicated 3-dimensional shapes, including objects with complex internal structures and passages. Such shapes can be prototyped and fabricated using 3D printing techniques in ways that would either not be possible using conventional fabricating techniques, or would require complex and multipart molds and the like.

3D printing or additive manufacturing techniques generally involve systems which build up a three dimensional object one layer at a time using computer-based templates that define multiple slices through the object. In one form of 3D printing based on micro-nozzle technology originally developed for inkjet printers, filaments of material, generally a plastic, are melted in an array of heated micro-nozzles. The melted filaments are extruded through the micro-nozzles under computer control in a pattern that corresponds to a 2-dimensional slice through a desired object. The entire 3D object is built up in this manner by depositing materials in successive layers.

3D printing technology using such micro-nozzle printing techniques may also use various forms of wax which are melted and deposited in precise computer-controlled patterns to generate, on a layer-by-layer basis, a wax replica of an object.

Another 3D printing technique based on building up additive layers is to first deposit a layer of a powder or particulate material followed by the deposit of adhesive on the powder or particulate in a computer-controlled pattern. Successive layers of powder or particulate and adhesive are deposited to form the 3D object. Powder or particulate that has not been bonded together by the adhesive during this process is readily removed, leaving a 3D replica of the desired object constructed from the combination of the powder or particulate material that has been bonded to other powder or particulate material by the adhesive. A large variety of powders or particulates may be used for such fabrication, including but not limited to sand, various plastics such as polyvinyl chloride or other polymers, metal powders, non-metal powders and mixtures thereof.

In yet another 3D printing technique, a 3D object can be formed by selectively polymerizing a layer of liquid photopolymer. The polymerization process may generally be performed using a computer-controlled laser beam followed possibly by a subsequent cure step.

Other 3D printing techniques include use of extruded polymers which can be hardened by light or selective laser sintering techniques in which a laser is used to selectively melt powder materials to form the desired 3D object.

The production of ceramic parts by 3D printing has serious constraints. As discussed above, the common method is to successively print a binder on a layer of loose ceramic particles to directly build up the ceramic object. The final object prepared by the foregoing techniques is often porous since the particle packing of loose particles is limited. The porosity is also the result of the layer-by-layer build-up process used in most 3D printing techniques, including in particular, techniques that rely on the application of adhesive layers to bind powder particles together. While the particle density can be enhanced by vibration or careful sizing of the particles, this is not easy to control. Furthermore, fine particles produce dust which can cause problems with the equipment. Ceramics fabricated by 3D printing may often require post treatments to form an object having a desired sufficiently high density.

As explained above, direct 3D printing of ceramic objects typically results in a finished object that is inherently porous and which therefore may not be suitable for certain applications, such as high quality ceramic objects and the like, where it is often desirable to have a highly dense ceramic as opposed to the porous ceramics that may be manufactured using such 3D printing technology.

On the other hand, conventional prior art casting and fabrication technology permits manufacture of non-porous ceramics and metals. However, such conventional technology generally uses plaster molds (or molds made from other relatively porous materials) into which a ceramic slip is poured.

In this case, the porosity of the plaster mold is advantageous since it permits removal of water or other solvents present in the slip through an osmosis process, which may be enhanced by a drying/heating process. Generally, drying/heating of the molded slip results in the expedited removal of the water/solvent through the porous mold and the formation of a “green” ceramic object that has sufficient structural integrity to subsequently be fired or sintered at higher temperatures to make the ceramic more dense.

However, traditional plaster molds and the like used in ceramics manufacture cannot be readily formed into intricate shapes that may desired for the ceramic object. Further, such traditional molds are not suitable for fabricating very thin portions of the object to be formed. Further, since such traditional molds are removed prior to the ceramic firing process, a certain amount of breakage of the intricate and delicate green objects may occur during the removal process. Further, since the mold is removed prior to the firing process, it typically must be separately and subsequently destroyed, leading to waste of material and time, as well as requiring space in landfills or other warehousing space.

### SUMMARY OF THE INVENTION

By using 3D printing or additive manufacturing technique to fabricate molds (which may be either porous or non-porous) and using conventional mold casting techniques with such molds, objects (e.g., ceramic objects, metal objects, etc.) having complex shapes and high density could be manufactured.

A porous mold is prepared containing the cavity of a part to be produced in ceramic or other material such as powdered metal. The mold may be prepared by various methods common to the 3-D printing or additive manufacturing process, for example, by use of a 3D printing machine manufactured by Voxeljet Technology GmbH. This machine successively prints layers of a binder (e.g. superglue) onto layers of acrylic particles to build up a 3D object, in this case, a mold. This plastic 3D mold, as formed, is quite strong and easily handled.

A conventional slurry of ceramic or other particles suspended in water, alcohol, wax or other material may be poured or injected into a porous mold. Since the mold is porous, the liquid portion of the slurry may be extracted through the pores by in-situ drying and/or heating to produce an unfired “green” piece that may be further processed into an article.

The porous mold may be readily decomposed and/or removed during the drying/heating process or by subsequent chemical dissolution; and the “green” piece may be fired by conventional means to produce, for example, a dense ceramic object of complex shapes. The drying/heating process and the mold removal may occur at substantially the same time.

The foregoing concepts may be further expanded to include the use of 3-D printed or additive printed non-porous molds for the manufacture of complex-shaped objects made from ceramics, metals or other materials.

When using non-porous molds, the setting of the slip material may be accomplished, for example, by a cement-type reaction or by causing a gel to be formed in the molded material mixture. The gel may be formed, for example, by freezing the mixture or by adjusting the PH of the mixture to cause gelation. In either case, the 3D-printed mold does not have to be porous, since the setting of the slip material in the mold to form a “green” piece does not rely on the porosity of the mold.

At least one embodiment of the present invention relates to a method of making an object (e.g., a ceramic object, metal object, etc.), comprising the steps of applying a slip mixture into a mold fabricated by 3D printing or additive manufacturing technique, and firing the mold containing the slip mixture.

In a further embodiment, the mold is porous.

In a further embodiment, the mold is non-porous.

In a further embodiment, the method further comprises the step of chemically decomposing the mold.

In a further embodiment, the mold is made of a material soluble in acetone, d-limonene, or water.

In a further embodiment, the firing step comprises the step of thermally decomposing the mold.

In a further embodiment, the mold is made of acrylic particles, nylon particles, or a mixture of thermoplastic powders coated with photosensitive polymers.

In a further embodiment, the mold is made of polyactic acid (PLA), acrylonitrile butadiene styrene (ABS), polyvinyl alcohol (PVA), or styrene butadiene copolymer.

In a further embodiment, the mold is made of wood flour incorporated in PLA, PVA, or ABS.

In a further embodiment, the slip mixture comprises calcium aluminate.

In a further embodiment, the slip mixture further comprises a filler.

In a further embodiment, the filler comprises one or more of raw silica sand and feldspar.

In a further embodiment, the slip mixture further comprises a nylon fiber.

In a further embodiment, the slip mixture comprises feldspar, and R&R 780 investment.

In a further embodiment, the slip mixture comprises 1130 colloidal silica.

In a further embodiment, the slip mixture further comprises one or more of acrylic water suspension and fused silica.

In a further embodiment, the 3D printing or additive manufacturing technique comprises fused deposition modeling technique.

In a further embodiment, the 3D printing or additive manufacturing technique comprises selective laser sintering.

In a further embodiment, the 3D printing or additive manufacturing technique comprises bonding acrylic particles together by ink jet printing a glue onto the particles.

In a further embodiment, the 3D printing or additive manufacturing technique comprises applying a laser to a mixture of thermoplastic powders coated with photosensitive polymers to selectively activate the polymers.

Furthermore, at least one embodiment of the present invention relates to a method of making an object (e.g., a ceramic object, metal object, etc.), comprising the steps of applying a slip mixture into a mold fabricated by 3D printing or additive manufacturing technique, processing the mold containing the slip mixture to form a green piece, substantially removing the mold from the green piece, and firing the green piece.

In a further embodiment, the mold is porous.

In a further embodiment, the mold is non-porous.

In a further embodiment, the step of substantially removing the mold comprises the step of chemically decomposing the mold.

In a further embodiment, the mold is soluble in acetone, d-limonene, or water.

In a further embodiment, the step of processing the mold comprises freezing the slip mixture and the step of substantially removing the mold comprises placing the mold containing the slip mixture in an acetone bath.

In a further embodiment, the mold is made of acrylic particles, nylon particles, or a mixture of thermoplastic powders coated with photosensitive polymers.

In a further embodiment, the mold is made of polyactic acid (PLA), acrylonitrile butadiene styrene (ABS), polyvinyl alcohol (PVA), or styrene butadiene copolymer.

In a further embodiment, the mold is made of wood flour incorporated in PLA, PVA, or ABS.

In a further embodiment, the slip mixture comprises calcium aluminate.

In a further embodiment, the slip mixture further comprises a filler.

In a further embodiment, the filler comprises one or more of raw silica sand and feldspar.

In a further embodiment, the slip mixture further comprises a nylon fiber.

In a further embodiment, the slip mixture comprises feldspar, and R&R 780 investment.

In a further embodiment, the slip mixture comprises 1130 colloidal silica.

In a further embodiment, the slip mixture further comprises one or more of acrylic water suspension and fused silica.

In a further embodiment, the 3D printing or additive manufacturing technique comprises fused deposition modeling technique.

In a further embodiment, the 3D printing or additive manufacturing technique comprises selective laser sintering.

In a further embodiment, the 3D printing or additive manufacturing technique comprises bonding acrylic particles together by ink jet printing a glue onto the particles.

In a further embodiment, the 3D printing or additive manufacturing technique comprises applying a laser to a mixture of thermoplastic powders coated with photosensitive polymers to selectively activate the polymers.

In addition, at least one embodiment of the present invention relates to a composition of a slip mixture for use with a mold fabricated by 3D printing or additive manufacturing technique, the composition comprising calcium aluminate, from 10% to 60% by weight, and a filler.

In a further embodiment, the filler comprises one or more of raw silica sand and feldspar.

In a further embodiment, the composition further comprises a nylon fiber.

In a further embodiment, the mold is non-porous.

In a further embodiment, the mold is thermally decomposable.

In a further embodiment, the mold is made of polyactic acid (PLA).

Furthermore, at least one embodiment of the present invention relates to a composition of a slip mixture for use with a mold fabricated by 3D printing or additive manufacturing technique, the composition comprising feldspar and R&R 780 investment, equally by weight.

In a further embodiment, the mold is non-porous.

In a further embodiment, the mold is thermally decomposable.

In a further embodiment, the mold is made of polyactic acid (PLA).

Furthermore, at least one embodiment of the present invention relates to a composition of a slip mixture for use with a mold fabricated by 3D printing or additive manufacturing technique, the composition comprising 1130 colloidal silica, from 10% to 70% by weight, and a filler.

In a further embodiment, the filler comprises one or more of acrylic water suspension and fused silica.

In a further embodiment, the mold is non-porous.

In a further embodiment, the mold is chemically decomposable.

In a further embodiment, the mold is made of a material soluble in acetone.

In a further embodiment, the mold is made of acrylonitrile butadiene styrene (ABS).

These and other features of the present invention are described in, or are apparent from the following detailed description of various exemplary embodiments of the invention.

### BRIEF DESCRIPTION OF THE DRAWINGS

The invention itself, as well as a preferred mode of use, further objects, and advantages thereof, will best be understood by reference to the following detailed description of illustrative and exemplary embodiments when read in conjunction with the accompanying drawings, wherein:

FIGS. 1A and 1B are views from different perspectives of an exemplary mold fabricated by 3D printing technology.

FIG. 2 illustrates an object manufactured using the mold illustrated in FIG. 1, in accordance with an exemplary embodiment of the present invention.

FIG. 3 illustrates another exemplary mold fabricated by 3D printing technology.

FIG. 4 illustrates an object manufactured using the mold illustrated in FIG. 3, in accordance with an exemplary embodiment of the present invention.

FIG. 5 shows yet another exemplary molds fabricated by 3D printing technology.

FIG. 6 shows one of the molds of FIG. 5 containing a slip mixture in its cavity prior to firing, in accordance with an exemplary embodiment of the present invention.

### DETAILED DESCRIPTION OF PREFERRED EMBODIMENTS

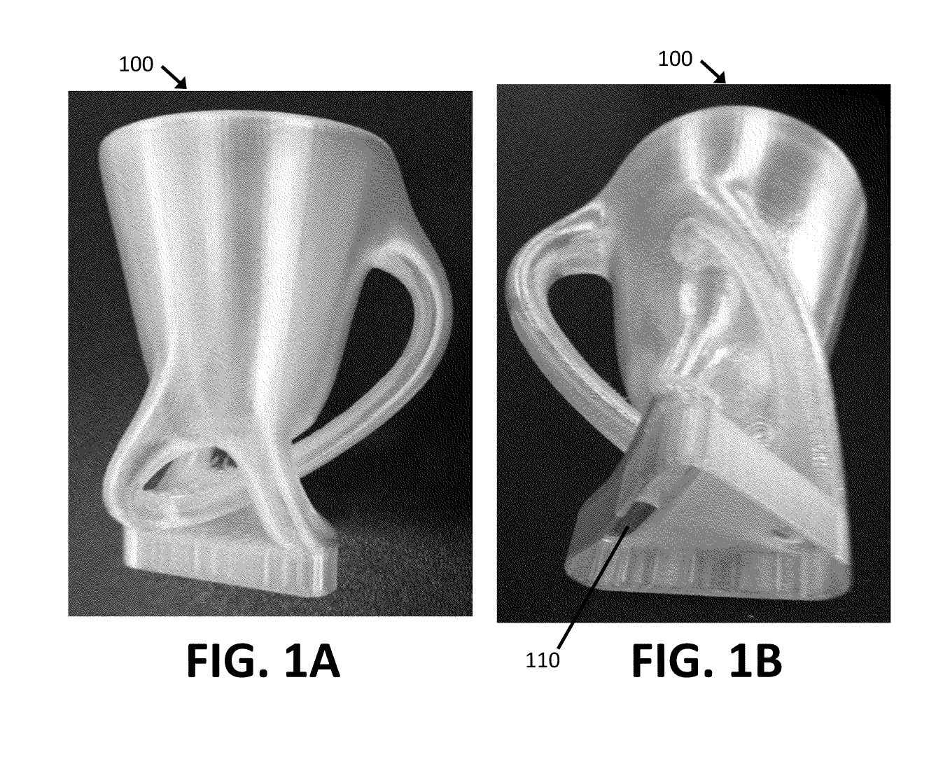

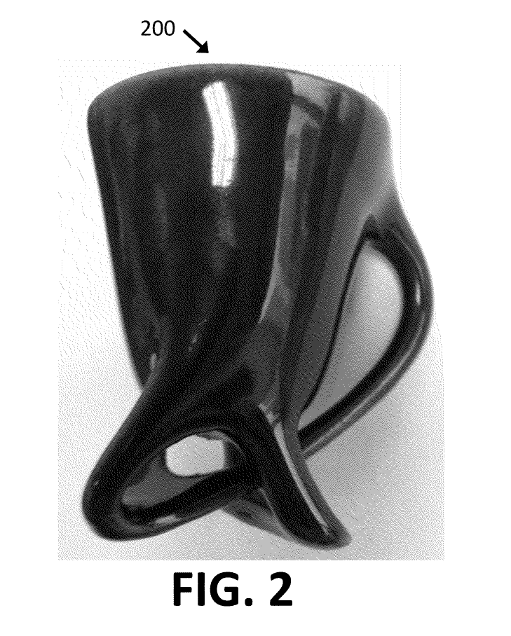

Porous or non-porous molds can be fabricated by using 3D printing or additive manufacturing technique, such as FDM technology. FIGS. 1A and 1B are views from different perspectives of an exemplary mold 100 fabricated by 3D printing technique (e.g., FDM). In FIG. 1B, the underside of the mold reveals holes 110 through which a slip mixture can be applied into the mold cavity for mold casting. The conventional mold casting technique can be applied to such molds to produce an object, such as a ceramic or metal object. FIG. 2 illustrates an exemplary dense ceramic object 200 (e.g., a cup-like object) made by applying the conventional mold casting technique to the mold illustrated in FIG. 1.

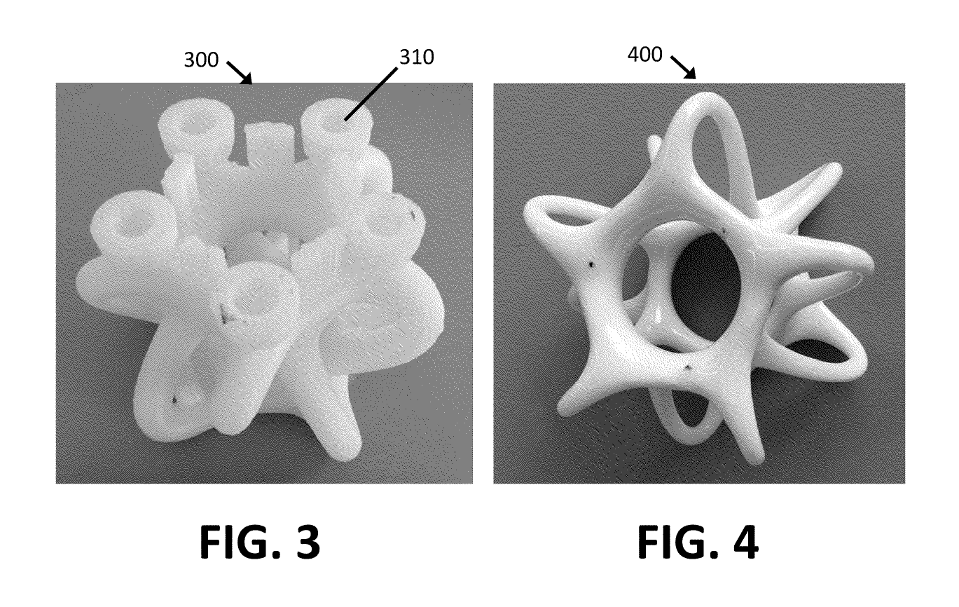

FIG. 3 illustrates another exemplary mold 300 fabricated by 3D printing technique (e.g., FDM). The upper portion of the mold reveals circular holes 310 through which a slip mixture can be applied into the mold cavity for mold casting. FIG. 4 illustrates an exemplary dense ceramic object 400 (e.g., a decorative ornament) made by applying the conventional mold casting technique to the mold shown in FIG. 3.

As shown in FIGS. 2 and 4, objects having complex, intricate shapes and high density can be manufactured from molds fabricated by 3D printing or additive manufacturing techniques in accordance with exemplary embodiments of the present invention. As discussed above, it is difficult to produce such objects having both complex shapes and high density using either the conventional mold casting method or the direct 3D printing fabrication method.

Materials for fabricating a porous mold using 3D printing can be chosen so as to readily decompose under heat, light or other means. This permits the porous mold to be automatically removed/decomposed, for example, during the initial heating step used to form the green ceramic. To facilitate removal of the mold, the walls of the mold may be dimensioned and manufactured using 3D printing to be relatively thin, but having a thickness sufficient to retain the ceramic slip until it is transformed into the “green” ceramic.

Porous molds can be fabricated, for example, by bonding acrylic particles together by ink jet printing a “glue,” such as superglue (cyanoacrylate), onto particles using 3-D printing machines manufactured by Voxeljet Technology GmbH.

Porous molds may also be produced by various 3-D printing machines that use a technique known as selective laser sintering, to bond together nylon particles by selectively heating the particles with a laser. This technique may be applied not only to nylon particles, but to various types of plastic materials.

Another 3-D printing technique that may be used to produce porous molds is to create a powder bed containing a mixture of fine thermoplastic powders that is coated with, for example, a photosensitive polymer of the type used in stereo-lithography. A laser may be used to activate the polymer in order to selectively bond the particles together.

The foregoing techniques may be used to make molds using many different types of particles, including plastic particles, ceramic particles, and metallic particles.

Such ceramic objects can also be manufactured using non-porous molds manufactured by 3D printing or other additive technologies.

When using such non-porous molds, the green piece may be set without relying on the porosity of the mold to facilitate removal of the water or other solvents present in this slip.

For example, in one embodiment, the green piece may be set in a non-porous mold by a cement-type reaction in which, for example, calcium aluminate cement is mixed with water and other ceramic materials to form a slip. Once set, the mold containing the set material may be placed into a conventional kiln and fired. During firing, the mold will decompose, leaving a densified cast ceramic, or metal article. This article thereafter may be glazed, if desired, in a conventional manner.

An example of such process may start with a slip formed from the following materials:

### Example 1

20 grams calcium aluminate (cement)
30 grams raw silica sand
50 grams feldspar
0.5 grams nylon fiber; and
24 grams water

Such formulation can be varied. For example, the amount of calcium aluminate may vary from approximately 10% to 60% of the slip mixture by weight. However, due to the cost of this ingredient, it is preferable to use less calcium aluminate as long as it is at least 10% of the slip mixture by weight.

Raw silica sand and feldspar are filler materials. Feldspar acts as a fusing agent. The effectiveness of the above formulation is not sensitive to the amount of these filler materials in the slip mixture. Instead of or in addition to raw silica and feldspar, any kind of ceramic material can be used as filler materials for this formulation.

As shown in the above example, nylon fiber or similar types of organic or inorganic fiber can be added to reinforce the strength of a green piece. However, addition of such fiber is not essential to the above formulation.

The amount of water in the formulation can also vary depending on the desired levels of flow and strength of the slip mixture.

By way of further example, after adding the water to the foregoing mixture of materials and mixing for a short period of time, the mixture can be poured into a non-porous plastic mold that has been fabricated using 3D printing or other additive process.

By way of example, such non-porous plastic mold may comprise polylactic acid (PLA) and can be manufactured on a 3-D printing machine such as a Makerbot Replicator 2 machine.

The setting process using the above slip mixture will take approximately 2 hours. Thereafter, the mold containing the now-set mixture slip may be placed in a conventional kiln and fired to approximately 2250° F. Firing may be done slowly or rapidly. It has been observed that under such firing conditions, the PLA mold will decompose without harming the cast article.

As another example, a slip mixture may be formed from materials that include a phosphate binder:

### Example 2

50 grams feldspar
50 grams of R&R 780 investment (this is a commercially available investment manufactured by Ransom & Randolph that includes phosphate binder mixed with raw silica)
29 grams water

The foregoing mixture may be put into a non-porous (PLA) mold and processed in accordance with the steps provided above.

Even though the above formulation is preferred, other formulation can be used as long as there is sufficient phosphate binder material to create a ceramic bond.

In an alternative embodiment, a non-porous mold may be removed prior to firing. An example of such process may include a slip mixture of:

### Example 3

50 grams water
10 grams acrylic water suspension
50 grams 1130 colloidal silica (commercially available, for example, from Nalco Co.)
336 grams fused silica (WDS commercially available from Minco Inc.)

Such formulation can be varied. For example, the amount of 1130 colloidal silica may vary from approximately 10% to 70% of the slip mixture by weight. Colloidal silica comprises superfine particles of silica and forms strong bonds when frozen. Thus, the more colloidal silica there are in the formulation, the stronger the slip mixture is when frozen. However, due to the cost of this ingredient, it is preferable to use less colloidal silica as long as it is at least 10% of the slip mixture by weight.

In this embodiment, the mixture may be put into a mold prepared on a 3D printing machine using ABS (acrylonitrile butadiene styrene) plastic filament material. The ABS mold containing the foregoing mixture may be placed into a freezer at 0° F. for approximately 2 hours. After freezing, the frozen mixture will have set as a gel or as ice or as a combination of gel and ice. The mold and frozen mixture may then be placed in an acetone bath at 0° F. The acetone will dissolve the ABS mold without harming the green piece. The green piece with the ABS material completely or partially removed may thereafter be placed in a bed of fused silica powder, other suitable powder, or on another suitable support structure, and then fired in a conventional kiln.

The slip mixtures having the formulations of the present invention are specifically suitable to fabrication in molds that are non-porous as there is no need to eliminate liquid. In an exemplary embodiment of the present invention, the mold can be removed, or when processed as described herein, the mold will decomposed by heat or solvents to release the green article without damage to such article.

By using slip mixtures that can be set by various processes such as conventional cement or gelling, non-porous molds manufactured by 3D printing may be used to easily fabricate complex shapes in ceramic, metal or other materials suitable for casting.

As described above, the non-porous molds may be automatically thermally decomposed during the firing process, or may be chemically decomposed at lower temperatures.

The primary advantage of molds that are readily decomposed, such as by heat or solvents, is that they enable the green piece to be freed from the mold without damaging thin walls or complex shapes molded into the green piece. Thus, green pieces can be molded with much finer details and more complex shapes than the prior processes.

Molds that can be thermally decomposed can be used with various binder systems that includes cement such as Portland cement or calcium aluminate cement as used in Example 1 above.

Other binder systems may include various sol-gel systems. For example ethyl silicate may be gelled by the addition of MgO.

In addition, thermoset materials such as silicone resin mixtures, various epoxy mixtures, urethane resins and acrylic resins, as well as mixtures of epoxy resins and silicone resins, and mixtures of various thermoset resins may be set by the addition of a catalyst.

In addition, mixtures of wax such as paraffin may be set in a mold by cooling, and the mold may be decomposed without melting the wax.

Plastic binders such as polystyrene, polyvinyl chloride (PVC), PLA and other plastics may also be used to set various types of ceramic material so that these materials may be fired in a mold that can be thermally decomposed during the firing process.

Molds that can be chemically decomposed, may be formed from polyvinyl alcohol (PVA), which is soluble in water. Such water-soluble PVA may be used as the mold material for casting articles that are set by one or more of the aforementioned binder materials. Other chemically-decomposable molds that are soluble water or other solvents may be formed using composite materials such as wood flour incorporated in PLA, PVA, or ABS.

As another example, a mold can be formed from styrene butadiene copolymer which is soluble in d-limonene. Such mold may be dissolved without affecting the binders mentioned above, except for wax. In addition, resin molds formed by photopolymers may be formed by 3D printing or additive manufacturing technologies and thereafter chemically dissolved after the cast materials have been set, to the extent that solvents are available for such photopolymers.

By using fabrication methods in accordance with the present invention, complex ceramic shapes can be formed using non-porous molds manufactured by 3D printing, and the mold fabrication and removal process can be greatly simplified over conventional casting technologies. In this way, objects having complex shapes and high density can be fabricated efficiently and economically.

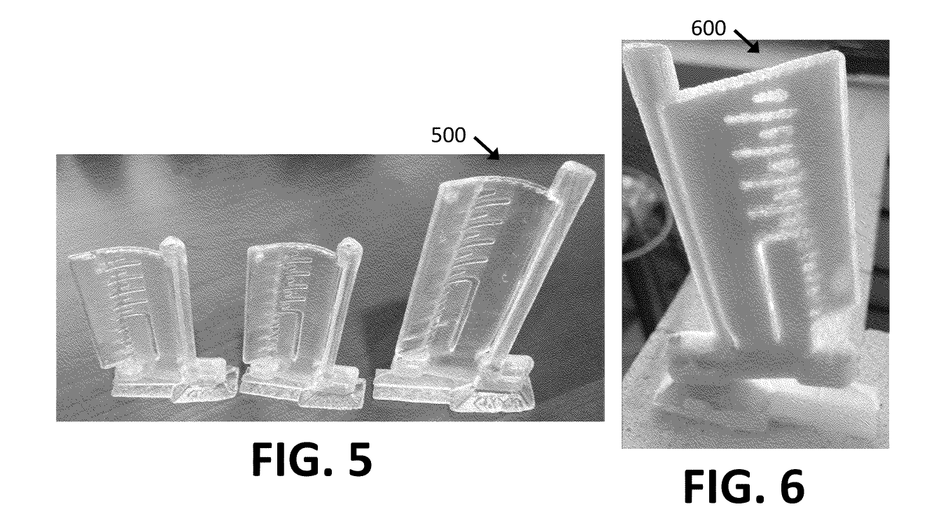

Multiple practical applications are envisioned for this invention, ranging from the manufacture of utilitarian sanitary items such as ceramic toilet bowls, to the manufacture of dense ceramic or metal objects having complex shapes, for example, as may be needed for use as cores for advanced turbine blades or other applications. FIG. 5 shows exemplary molds 500 for the core of such turbine blades, which are fabricated by 3D printing technique (e.g., FDM) and FIG. 6 shows one of the molds of FIG. 5 600 containing a ceramic slip mixture in its cavity prior to firing, in accordance with an exemplary embodiment of the present invention. The molded core is then used for the manufacture of a turbine blade.

While this invention has been described in conjunction with exemplary embodiments outlined above and illustrated in the drawings, it is evident that many alternatives, modifications and variations in form and detail will be apparent to those skilled in the art. Accordingly, the exemplary embodiments of the invention, as set forth above, are intended to be illustrative, not limiting, and the spirit and scope of the present invention is to be construed broadly and limited only by the appended claims, and not by the foregoing specification.

What is claimed is:

1. A method of making an object, comprising the steps of:
applying a slip mixture into a mold fabricated by 3D printing or additive manufacturing technique; and
firing the mold containing the slip mixture.

2. The method of claim 1, wherein the mold is porous.

3. The method of claim 1, wherein the mold is non-porous.

4. The method of claim 1, further comprising the step of chemically decomposing the mold.

5. The method of claim 1, wherein the mold is made of a material soluble in acetone, d-limonene, or water.

6. The method of claim 1, wherein the firing step comprises the step of thermally decomposing the mold.

7. The method of claim 1, wherein the mold is made of acrylic particles, nylon particles, or a mixture of thermoplastic powders coated with photosensitive polymers.

8. The method of claim 1, wherein the mold is made of polyactic acid (PLA), acrylonitrile butadiene styrene (ABS), polyvinyl alcohol (PVA), or styrene butadiene copolymer.

9. The method of claim 1, wherein the mold is made of wood flour incorporated in PLA, PVA, or ABS.

10. The method of claim 1, wherein the slip mixture comprises calcium aluminate.

11. The method of claim 10, wherein the slip mixture further comprises a filler.

12. The method of claim 11, wherein the filler comprises one or more of raw silica sand and feldspar.

13. The method of claim 10, wherein the slip mixture further comprises a nylon fiber.

14. The method of claim 1, wherein the slip mixture comprises feldspar, and R&R 780 investment.

15. The method of claim 1, wherein the slip mixture comprises 1130 colloidal silica.

16. The method of claim 15, wherein the slip mixture further comprises one or more of acrylic water suspension and fused silica.

17. The method of claim 1, wherein the 3D printing or additive manufacturing technique comprises fused deposition modeling technique.

18. The method of claim 1, wherein the 3D printing or additive manufacturing technique comprises selective laser sintering.

19. The method of claim 1, wherein the 3D printing or additive manufacturing technique comprises bonding acrylic particles together by ink jet printing a glue onto the particles.

20. The method of claim 1, wherein the 3D printing or additive manufacturing technique comprises applying a laser to a mixture of thermoplastic powders coated with photosensitive polymers to selectively activate the polymers.

21. The method of claim 1, wherein the object is a ceramic object or a metal object.

22. A method of making an object, comprising the steps of:
applying a slip mixture into a mold fabricated by 3D printing or additive manufacturing technique;
processing the mold containing the slip mixture to form a green piece;
substantially removing the mold from the green piece; and
firing the green piece.

23. The method of claim 22, wherein the mold is porous.

24. The method of claim 22, wherein the mold is non-porous.

25. The method of claim 22, wherein the step of substantially removing the mold comprises the step of chemically decomposing the mold.

26. The method of claim 22, wherein the mold is soluble in acetone, d-limonene, or water.

27. The method of claim 22, wherein the step of processing the mold comprises freezing the slip mixture and the step of substantially removing the mold comprises placing the mold containing the slip mixture in an acetone bath.

28. The method of claim 22, wherein the mold is made of acrylic particles, nylon particles, or a mixture of thermoplastic powders coated with photosensitive polymers.

29. The method of claim 22, wherein the mold is made of polyactic acid (PLA), acrylonitrile butadiene styrene (ABS), polyvinyl alcohol (PVA), or styrene butadiene copolymer.

30. The method of claim 22, wherein the mold is made of wood flour incorporated in PLA, PVA, or ABS.

31. The method of claim 22, wherein the slip mixture comprises calcium aluminate.

32. The method of claim 31, wherein the slip mixture further comprises a filler.

33. The method of claim 32, wherein the filler comprises one or more of raw silica sand and feldspar.

34. The method of claim 31, wherein the slip mixture further comprises a nylon fiber.

35. The method of claim 22, wherein the slip mixture comprises feldspar, and R&R 780 investment.

36. The method of claim 22, wherein the slip mixture comprises 1130 colloidal silica.

37. The method of claim 36, wherein the slip mixture further comprises one or more of acrylic water suspension and fused silica.

38. The method of claim 22, wherein the 3D printing or additive manufacturing technique comprises fused deposition modeling technique.

39. The method of claim 22, wherein the 3D printing or additive manufacturing technique comprises selective laser sintering.

40. The method of claim 22, wherein the 3D printing or additive manufacturing technique comprises bonding acrylic particles together by ink jet printing a glue onto the particles.

41. The method of claim 22, wherein the 3D printing or additive manufacturing technique comprises applying a laser to a mixture of thermoplastic powders coated with photosensitive polymers to selectively activate the polymers.

42. The method of claim 22, wherein the object is a ceramic object or a metal object.

43. A composition of a slip mixture for use with a mold fabricated by 3D printing or additive manufacturing technique, the composition comprising calcium aluminate, from 10% to 60% by weight, and a filler.

44. The composition of claim 43, wherein the filler comprises one or more of raw silica sand and feldspar.

45. The composition of claim 43, further comprising a nylon fiber.

46. The composition of claim 43, wherein the mold is non-porous.

47. The composition of claim 43, wherein the mold is thermally decomposable.

48. The composition of claim 43, wherein the mold is made of polyactic acid (PLA).

49. A composition of a slip mixture for use with a mold fabricated by 3D printing or additive manufacturing technique, the composition comprising feldspar and R&R 780 investment, equally by weight.

50. The composition of claim 49, wherein the mold is non-porous.

51. The composition of claim 49, wherein the mold is thermally decomposable.

52. The composition of claim 49, wherein the mold is made of polyactic acid (PLA).

53. A composition of a slip mixture for use with a mold fabricated by 3D printing or additive manufacturing technique, the composition comprising 1130 colloidal silica, from 10% to 70% by weight, and a filler.

54. The composition of claim 53, wherein the filler comprises one or more of acrylic water suspension and fused silica.

55. The composition of claim 53, wherein the mold is non-porous.

56. The composition of claim 53, wherein the mold is chemically decomposable.

57. The composition of claim 53, wherein the mold is made of a material soluble in acetone.

58. The composition of claim 53, wherein the mold is made of acrylonitrile butadiene styrene (ABS).
